(19) United States
(12) Patent Application Publication
(10) Pub. No.: US 2013/0034790 A1
(43) Pub. Date: Feb. 7, 2013

(54) FUEL CELL STACK HAVING A STRUCTURAL HEAT EXCHANGER

(71) Applicants: Matthew Graham, West Palm Beach, FL (US); James Braun, Lake Worth, FL (US); Thomas Pavlik, North Palm Beach, FL (US)

(72) Inventors: Matthew Graham, West Palm Beach, FL (US); James Braun, Lake Worth, FL (US); Thomas Pavlik, North Palm Beach, FL (US)

(73) Assignee: ENERFUEL, INC., West Palm Beach, FL (US)

(21) Appl. No.: 13/566,347

(22) Filed: Aug. 3, 2012

Related U.S. Application Data
(60) Provisional application No. 61/515,335, filed on Aug. 5, 2011.
(60) Provisional application No. 61/523,975, filed on Aug. 16, 2011.

(51) Int. Cl. H01M 8/04

(52) U.S. Cl. 429/435; 429/434

(57) ABSTRACT

Disclosed are fuel cell stacks incorporating heat exchangers capable of also acting as members to compress the fuel cell stack. Heat exchange through conduction is enabled by placing the heat exchanger into contact with the edges of the bipolar plates. A compressive force within the fuel cell stack is achieved by placing the heat exchanger in tension between the endplates at the opposite ends of the fuel cell stack.

### CROSS REFERENCE TO RELATED APPLICATIONS

This application claims priority to U.S. provisional application No. 61/515,335, filed Aug. 5, 2011 and to U.S. provisional application No. 61/523,975, filed Aug. 16, 2011, which are hereby incorporated by reference in their entireties.

### BACKGROUND OF THE DISCLOSURE

The present disclosure relates to fuel cell stacks including heat exchangers that are capable of also acting as tensile members to maintain a compressive force on the other components of the fuel cell stacks. The heat exchangers, and in particular, cold plates, are placed in contact with the bipolar plates and/or endplates to apply and maintain a compressive force within the cross-sectional cell area, eliminating the cantilevered load and enabling the use of thinner, alternative materials for the endplates. This reduces the overall thermal mass and size of the fuel cell stacks.

Some known fuel cells comprise a fuel cell stack having a plurality of bipolar plates interleaved with suitable a electrolyte and anode and cathode electrodes (e.g., membrane electrode assemblies (MEA)). During the operation of the fuel cell stack, hydrogen is oxidized which produces electricity and heat. More specifically, the hydrogen is split into positive hydrogen ions and negative charged electrons. The electrolyte allows the positive hydrogen ions to pass through to the cathode. The negative charged electrons, which are unable to pass through the electrolyte, travel along an external pathway to the cathode thereby forming an electrical circuit.

At the cathode, the negative charged electrons are combined with the positive hydrogen ions to form water. During this process, the bipolar plates act as current conductors between cells, provide conduits for introducing the reactants (e.g., hydrogen, oxygen) into the cells, distribute the reactants throughout the cell, maintaining the reactants separate from cell anodes and cathodes, and provide discharge conduits for the water, unused reactants, and any other by-products to exit the system.

In order for the fuel cell stack to function properly, the bipolar plates and MEA must be compressed together for sufficient contact and transfer of reactants. More particularly, the MEA is compressed between the bipolar plates to allow transfer of the reactants. Fuel cell stacks are typically constructed using tie-rods around the periphery of the cross-sectional area to apply a compressive force sufficient to compress the assembly and seal gases between the bipolar plates inside the stack. These tie-rods generally pass through a series of spring washers and robust endplates, necessarily thick in order to resist deflection and bending due to the high cantilevered load applied thereto.

In addition to producing electricity, the chemical reactions that take place between the reactants in the fuel cell produce heat. Additionally, high temperature polymer electrolyte member (PEM) fuel cells, which operate at temperatures in the range of 120° C. to about 200° C., require initial heating (prior to application of reactants and electrical load) to a uniform temperature above 150° C. for use with reformant fuel. Excess heat needs to be removed for optimum operation of the fuel cell. Typically, excess heat is removed from fuel cells by the circulation of a heat transfer fluid through internal passages that are machined or otherwise formed in the bipolar plates. Alternatively, the use of bipolar plate fins to accomplish convective heat transfer to cooling air has also been used. These heat transfer approaches have been used with varying degrees of success, though both involve technical challenges including material compatibility of the heat transfer fluid with the bipolar plate and other materials in the fuel cell, and non-uniform temperature distribution. Additionally, as heat is generated within the fuel cell stack, components such as the bipolar plates expand, further applying force to the endplates of the stack.

Accordingly, there is a need in the art for the ability to apply and maintain a compressive force to compress the components within the fuel cell stack together for proper functioning, while eliminating the cantilevered load, thereby allowing the use of thinner, alternative materials for the endplates and reducing undesirable thermal mass and size of the overall fuel cell stack. It would be further beneficial if the members applying and maintaining the compressive force were heat exchangers, thereby further improving temperature uniformity within the stack.

### BRIEF DESCRIPTION OF THE DISCLOSURE

The present disclosure is directed to fuel cell stacks including heat exchangers, also referred to herein as cold plates, adapted to apply and maintain a compressive force on the components within the interior of the fuel cell stack, allowing for sufficient contact and transfer of reactants between fuel cell stack components. Further, the heat exchanger allows for greater temperature uniformity throughout the fuel cell stack.

In one embodiment, the present disclosure is directed to a fuel cell stack comprising a plurality of bipolar plates interleaved with membrane electrode assemblies; and a heat exchanger operably connected to an edge of the bipolar plates and adapted to maintain a compressive force on the bipolar plates and membrane electrode assemblies.

In another embodiment, the present disclosure is directed to a fuel cell stack comprising a plurality of bipolar plates interleaved with membrane electrode assemblies; and a heat exchanger operably connected to an edge of the bipolar plates and adapted to maintain a compressive force on the bipolar plates and membrane electrode assemblies. The heat exchanger has an in-plane coefficient of thermal expansion similar to the through-plane coefficient of thermal expansion of the bipolar plates.

In another embodiment, the present disclosure is directed to a fuel cell stack comprising a plurality of bipolar plates interleaved with membrane electrode assemblies; a first heat exchanger operably connected to an edge of the bipolar plates; a second heat exchanger operably connected to an opposing edge of the bipolar plates, wherein the first and second heat exchangers are adapted to maintain a compressive force on the bipolar plates and membrane electrode assemblies; and a compression spring assembly including a structural beam extending between the first and second heat exchangers and at least one spring connected to the structural beam for transferring force between the bipolar plates and each of the first and second heat exchangers. At least one of the first and second heat exchanger has an in-plane coefficient of thermal expansion similar to the through-plane coefficient of thermal expansion of the bipolar plates.

### BRIEF DESCRIPTION OF THE DRAWINGS

FIG. 1 is a frontside perspective view of a fuel cell stack according to a first embodiment of the present disclosure.

FIG. 2 is a backside perspective view of the fuel cell stack of FIG. 1.

FIG. 3 is a side view of the fuel cell stack of FIG. 1.

FIG. 4 is a back end view of the fuel cell stack of FIG. 1.

FIG. 5 is a front end view of the fuel cell stack of FIG. 1.

FIG. 6 is a top view of the fuel cell stack of FIG. 1.

FIG. 7 is an exploded view of the fuel cell stack of FIG. 1.

FIG. 8 is a backside perspective view of a tube-in-plate heat exchanger removed from the fuel cell stack of FIG. 1.

FIG. 9 is a plan view of the heat exchanger of FIG. 8.

FIG. 10 is a cross-section of the heat exchanger taken along line 10-10 of FIG. 9.

FIG. 11 is a frontside perspective view of a fuel cell stack according to a second embodiment of the present disclosure.

FIG. 12 is a backside perspective view of the fuel cell stack of FIG. 11.

FIG. 13 is a side view of the fuel cell stack of FIG. 11.

FIG. 14 is a front end view of the fuel cell stack of FIG. 11.

FIG. 15 is a back end view of the fuel cell stack of FIG. 11.

FIG. 16 is a top view of the fuel cell stack of FIG. 11.

FIG. 17 is an exploded view of the fuel cell stack of FIG. 11.

FIG. 18 is a frontside perspective view of a fuel cell stack according to a third embodiment of the present disclosure.

### DETAILED DESCRIPTION OF THE DISCLOSURE

The present disclosure is generally directed to the use of a heat exchanger adapted to apply and maintain a compressive force to at least one or more components of a fuel cell stack. In particular, the heat exchanger applies and maintains the compressive force on one or more of a bipolar plate, membrane electrode assembly (MEA), and/or seal, thereby compressing the MEA and/or seals between the bipolar plates to allow reaction by the reactants of the fuel cell stack, while maintaining a more uniform temperature throughout the stack. Further, by using the heat exchanger of material having a similar coefficient of thermal expansion (COTE) as that of the materials for the bipolar plates, MEA, and/or seal to maintain compressive force on the bipolar plate, MEA and/or seal, less variation in force is applied to the endplates. Further, locating the application of this force to the interior of the periphery of the fuel cell stack allows for thinner, alternative materials for the endplates and reducing the overall thermal size and mass of the fuel cell stack.

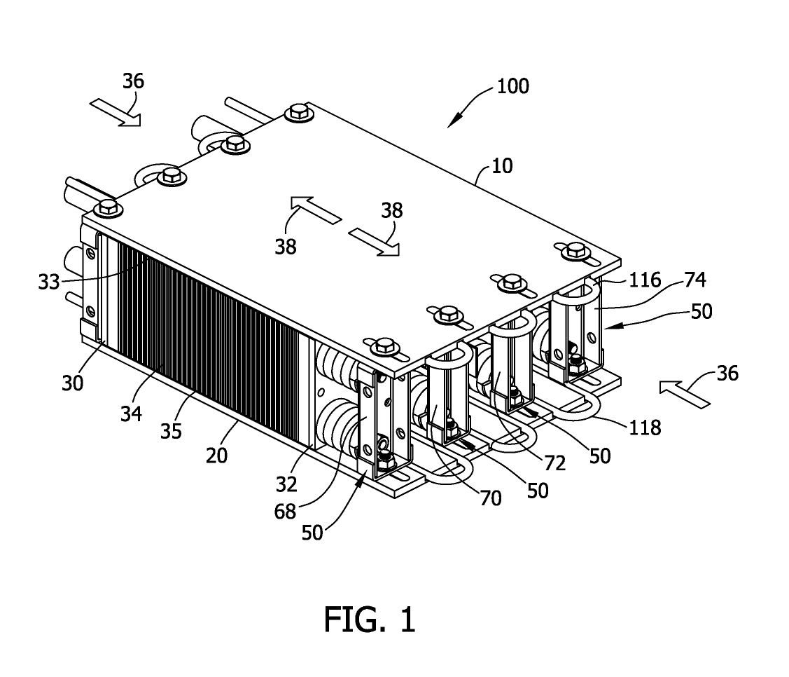

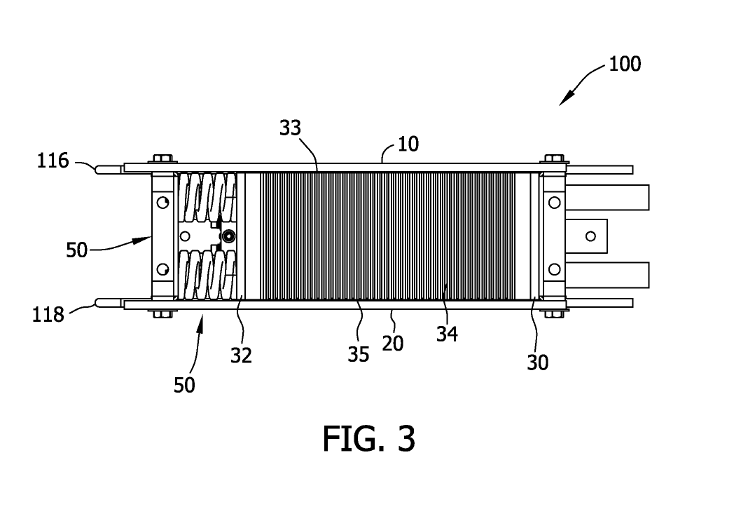

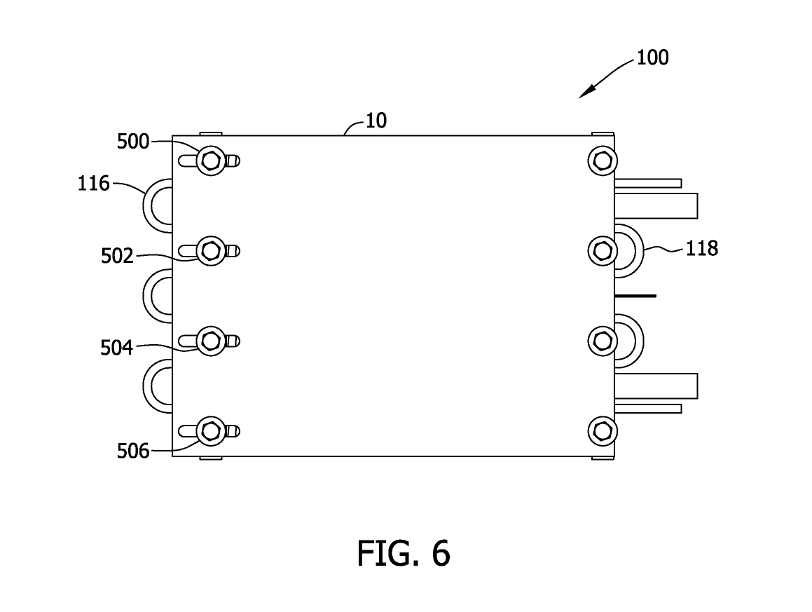

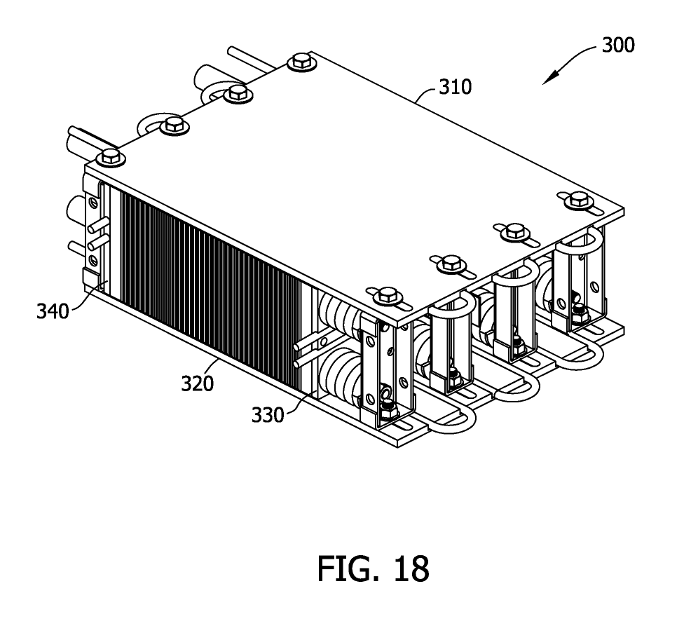

FIGS. 1-7 illustrate a fuel cell stack, indicated generally at 100, according to a first embodiment of the present disclosure. The fuel cell stack 100 includes a plurality of bipolar plates 34 interleaved with membrane electrode assemblies (MEA), a first heat exchanger 10 located on top of the fuel cell stack (as viewed in FIG. 1), and a second heat exchanger 20 located at the bottom of the fuel cell stack (as viewed in FIG. 1). While illustrated as having two heat exchangers 10, 20, it should be understood that the fuel cell stack 100 can have a single heat exchanger or can have more than two heat exchangers without departing from the present disclosure. For example, as shown in FIG. 18, the fuel cell stack includes four heat exchangers; a first heat exchanger 310 located on top of the fuel cell stack 300, a second heat exchanger 320 located at the bottom of the fuel cell stack 300, a third heat exchanger 330 located at the front end of the fuel cell stack 300, and a fourth heat exchanger 340 located at the back end of the fuel cell stack 300.

Referring to FIG. 1, the heat exchangers 10, 20 are adapted to heat and cool the stack 100 through conductive heat transfer with a fluid circulated through the heat exchangers. With the first heat exchanger 10 and the second heat exchanger 20 arrangement of FIGS. 1-7, for example, edge conduction of heat into the stack 100 for startup, and out of the stack for cooling during operation can be achieved. In one suitable embodiment, the heat transfer fluid is passed through an external heater (not shown), and then through the heat exchangers 10, 20 for startup heating. For cooling, the fluid is passed through the heat exchangers 10, 20, and then through an external radiator (not shown).

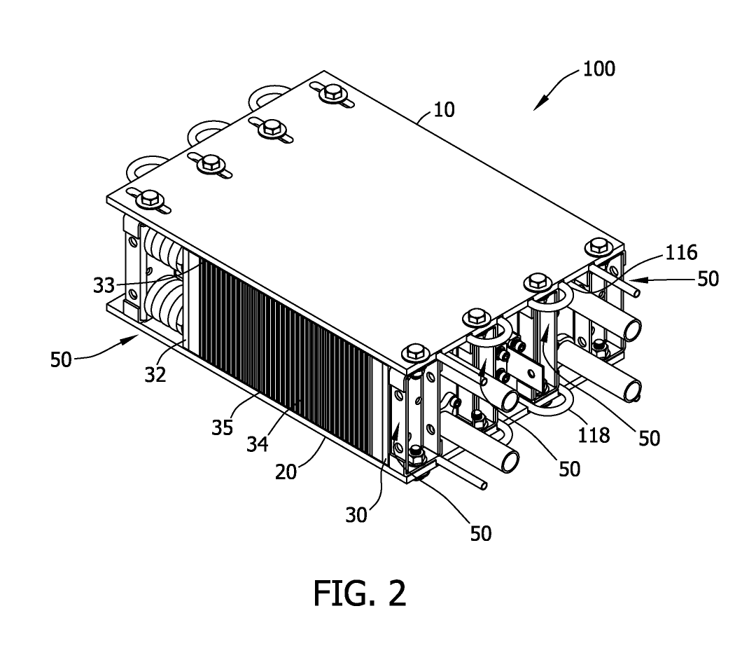

The illustrated heat exchangers 10, 20 are flat tube-in-plate heat exchangers including tubes 116, 118 that run through the heat exchangers 10, 20. In this configuration, fluid is circulated through the tubes 116, 118, to heat and/or cool the fuel cell stack 100. In some embodiments, heat transfer fluid is directed in a first direction in the first heat exchanger 10, and in a second opposite direction in the second heat exchanger 20. It has been found that when configuring the direction of the heat transfer fluid in a direction perpendicular to the edges of the bipolar plates 34 (e.g., left to right in the first heat exchanger 10, and right to left in the second heat exchanger 20 as shown in FIGS. 1 and 2), greater heat transfer occurs as a greater portion of the bipolar plates are in direct contact with the tubes carrying heat transfer fluid. This configuration also provides for greater uniformity of bipolar plate temperatures.

Suitable bipolar plates are described in U.S. patent Ser. Nos. 13/566,406; 13/566,531; 13/566,551; 13/566,585; and 13/566,629 filed Aug. 3, 2012, which are hereby incorporated by reference in their entireties. In one particularly suitable embodiment, the bipolar plates are included in a bipolar plate assembly having a first bipolar plate, a second bipolar plate, and at least one insert member disposed between the first and second bipolar plates. In one embodiment, the bipolar plate assembly has a generally rectangular box shape (i.e., a right cuboid).

The bipolar plate assembly includes apertures for allowing fluid (gas and/or liquid) to pass through the bipolar plate assembly. In some embodiments, the apertures extend through primary faces adjacent respective corners of the bipolar plate assembly. Each of the primary faces of the bipolar plate assembly additionally has a plurality of channels for distributing fluid across the respective primary face. In one particular embodiment, the channels on a first primary face are fluidly connected to two of the apertures and the channels on a second primary face are fluidly connected to another two apertures. As a result, one of the apertures acts as an inlet for the channels and the other aperture in fluid communication with the same channel acts as an outlet. The channels may have any configuration known in the art. For example, in one embodiment, the channels define a serpentine pathway for the fluid as the fluid flows from the aperture defining the inlet to the aperture defining the respective outlet. During use, the channels are designed to distribute reactant evenly across the fuel cell's membrane electrode assembly (MEA).

As seen in FIGS. 1-3, each of the heat exchangers 10, 20 is operably connected to the plurality of bipolar plates 34. In the illustrated embodiment, the first heat exchanger 10 is operably connected to the upper edges 33 of bipolar plates 34, and the second heat exchanger 20 is operably connected to the opposing lower edges 35 of bipolar plates 34. The number of bipolar plates 34 in the fuel cell stack 100 can be varied depending on the desired amount of power to be generated by the stack; that is, the more power desired, the greater number of bipolar plates and membrane electrode assemblies will be required. A 36-cell fuel stack, for example, is shown in FIGS. 1-7. However, the fuel cell stack 100 may include more or less than 36 cells, thereby including more or less bipolar plates and interleaved MEAs without departing from the present disclosure.

In order for the fuel cell stack 100 to function properly, the bipolar plates and MEA must be compressed together, and more particularly, the MEA must be compressed between the bipolar plates, for sufficient contact and transfer of reactants. In one suitable embodiment, the fuel cell stack 100 requires a compressive force (illustrated in FIG. 1 by arrows 36) to apply a pressure of from about 25 to about 250 psi, and including from about 50 to about 125 psi, on the interior components of the stack (e.g., bipolar plates, MEAs, and seals). The compressive force 36 is achieved and maintained by placing the heat exchangers 10, 20 in tension between the opposing ends (typically, and as shown in FIGS. 1-3, at endplates 30, 32) of the fuel cell stack 100. That is, by intimately contacting the heat exchangers 10, 20 to the opposing edges 33, 35 of the bipolar plates 34 and connecting the heat exchangers 10, 20 at the ends (such as through tie rods, studs, and structural beams as described more fully below), force (e.g., tensile force as illustrated in FIG. 1 by arrows 38) is transferred between the bipolar plates 34 and MEAs and the heat exchangers 10, 20. That is, compressive force 36 is applied to the bipolar plates 34 and MEAs and tensile force, such as during thermal expansion, is applied to the heat exchangers 10, 20.

When heat energy is generated by the fuel cell stack 100, the tensile force 38 will vary due to thermal expansion mismatches between the stack components, especially the bipolar plates 34. Bipolar plates 34 occupy most of the volume in the stack 100 and are the greatest contributors to thermal expansion. When the bipolar plates 34 expand, the tensile force 38 will vary from the initial tensile force applied during assembly of the fuel cell stack.

During stack operation or heat-up, when thermal expansion occurs, the bipolar plates 34 and other components expand according to the thermal load placed on them. Thermal expansion of the bipolar plates 34 may be different from that of the other stack components. In the illustrated embodiment, heat transfer fluid is introduced to regulate the temperature of the bipolar plates 34, however, in conventional fuel cell stacks, tensile members (such as dowels (i.e., tie rods), nuts, washers, and the like) do not experience the thermal load at the same rate as these members and are typically not in direct contact with the heat transfer fluid. For example, when the heat transfer fluid is used to heat-up the fuel cell stack 100, the bipolar plates 34 expand due to the thermal load applied by the heat transfer fluid. As the tensile members are not in direct contact with the heat transfer fluid, the members expand more slowly, which dramatically increases tensile loads within the fuel cell stack 100. A reverse phenomenon may occur as the stack 100 is cooled.

In the present disclosure, as the heat exchangers 10, 20 are in direct contact with the heat transfer fluid and are adapted to maintain a compressive force on the bipolar plates 34 and MEAs, the above described thermal expansion disadvantage is substantially avoided. That is, the heat exchangers 10, 20 experience thermal load at a similar rate as the bipolar plates 34, and thus, expand at a similar rate as the bipolar plates, lessening the overall compressive load on the fuel cell stack.

In one embodiment, the heat exchangers 10, 20 are further fabricated from a material whose coefficient of thermal expansion is similar to that of the bipolar plates 34. In one embodiment, at least a portion of the bipolar plates 34 are constructed from material having a relatively high in-plane thermal conductivity. Materials suitable for use as the bipolar plates 34 or portions thereof include, but are not limited to, a graphite foil comprising expanded natural or synthetic graphite that has been expanded or exfoliated and then recompressed. Examples include SPREADERSHIELD and GRAFOIL available from Graftech International Holdings of Parma, Ohio, U.S.A. and SIGRAFLEX available from SGL Carbon GmbH, of Wiesbaden, Germany. Other suitable materials include, for example, metal clad graphite foils, polymer impregnated graphite foils, other forms of carbon, including CVD carbon and carbon-carbon composites, silicon carbide, and high thermal conductivity metals or alloys containing aluminum, beryllium, copper, gold, magnesium, silver and tungsten.

In one suitable embodiment, the material used for the bipolar plates 34 or portions thereof has an in-plane electrical conductivity greater than 100 S/cm, more suitably greater than 500 S/cm, even more suitably greater than 1,000 S/cm, and most suitably greater than 2,000 S/cm while the through-plane electrical conductivity of the material would suitably be less than 50 S/cm, more suitably less than 40 S/cm, even more suitably less than 30 S/cm, less than 20 S/cm, less than 15 S/cm, and most suitably less than 10 S/cm. Suitably, the through-plane thermal conductivity of the material would be less than 20 W/mK, more suitably less than 15 W/mK, even more suitably less than 10 W/mK, less than 5 W/mK, and most suitably less than 3 W/mK while the in-plane thermal conductivity of the material would suitably be greater than 100 W/mK, more suitably greater than 200 W/mK, even more suitably greater than 300 W/mK, greater than 400 W/mK, and most suitably greater than 500 W/mK.

Suitably the through-plane thermal expansion of the material would be less than 90 ppm/° C., more suitably less than 60 ppm/° C., even more suitably less than 30 ppm/° C., and most suitably less than 25 ppm/° C. and the in-plane thermal expansion of the material would suitably be less than 5 ppm/° C., more suitably less than 3 ppm/° C., even more suitably less than 1 ppm/° C., less than 0 ppm/° C., and most suitably less than −0.3 ppm/° C. The density of the material would suitably be less than 1.9 g/cc, less than 1.8 g/cc, less than 1.7 g/cc, less than 1.6 g/cc, less than 1.5 g/cc, and more suitably less than 1.4 g/cc.

By mating the heat exchangers 10, 20 to the edges 33, 35 of bipolar plates 34 with relatively high in-plane thermal conductivity, the heat exchangers and the bipolar plates come up to temperature in unison when heat is applied. For example, when the heat exchangers 10, 20 are tube-in-plate heat exchangers, the thermal load is applied by circulating the heat transfer fluid through the fluid circuit in the heat exchangers. This heat is quickly conducted into the edges 33, 35 of the bipolar plates 34 with high in-plane thermal conductivity. The high in-plane thermal conductivity of the bipolar plates 34 allows heat energy to quickly travel into the center of the fuel cell stack 100. By these means, the heat exchangers 10, 20 and the bipolar plates 34 rise in temperature in unison. Through this configuration, both transient and steady state thermal expansions are matched.

Further, as the heat exchangers 10, 20 and bipolar plates 34 have similar coefficients of thermal expansion (COTE), the total tensile force is reduced. When thermal stresses are applied, such as during heat-up of the stack 100 or during operation, tensile forces on the heat exchangers 10, 20 do not reach extremes as the heat exchangers expand at the same rate and by roughly the same amount as the bipolar plates 34.

For comparison, in one embodiment, a bipolar plate material possesses a through-plane COTE of between about 7.5×10⁻⁵ in/in° C. and about 7.7×10⁻⁵ in/in° C. Two exemplary materials for use as heat exchangers include stainless steel with an in-plane COTE of between about 1.6×10⁻⁵ in/in° C. and about 1.8×10⁻⁵ in/in° C. and aluminum with an in-plane COTE of between 2.4×10⁻⁵ in/in° C. and about 2.5×10⁻⁵ in/in° C. For a 130-cell fuel cell stack using heat exchangers of stainless steel, it is determined that the thermal mismatch would be between about 0.281 and about 0.301 inches. If the heat exchangers were switched to aluminum, with an in-plane COTE of about 2.4×10⁻⁵ in/in° C. and about 2.5×10⁻⁵ in/in° C., the thermal expansion mismatch would be between about 0.245 and about 0.260 inches.

In contrast to above, in one particularly suitable embodiment of the present disclosure, a 130-cell fuel cell stack is designed utilizing a bipolar plate material having a through-plane COTE similar to the in-plane COTE of the heat exchanger. Particularly, the bipolar plate material possesses a COTE of between about 2.3×10⁻⁵ in/in° C. and about 2.5×10⁻⁵ in/in° C. When paired with a stainless steel heat exchanger in this embodiment, the fuel cell stack experiences a thermal expansion mismatch of only between about 0.023 and about 0.042 inches, and when paired with an aluminum heat exchanger, a thermal expansion mismatch of only between about 0.001 to about 0.005 inches. That is, the fuel cell stack in these two embodiments experiences substantially less thermal expansion mismatch as compared to the embodiment above as the through-plane COTE of the bipolar plate material is similar to the in-plane COTE of the heat exchangers. As used herein, the term “similar” when referring to COTEs refers to a heat exchanger having an in-plane COTE differing from the through-plane COTE of a bipolar plate of less than 15%, including less than 10%, including less than 7%, including less than 6%, including less than 5%, and even including less than 4%.

Excessive compressive force may cause deflection of the endplates 30, 32. This deflection at the ends of the fuel cell stack 100 governs the thickness and materials used for the components, and typically for the endplates 30, 32, of the fuel cell stack. That is, when greater deflection is experienced by the endplates 30, 32, thicker, heavier materials are required for the endplates to prevent the fuel cell stack 100 from failing. This adds size and weight to the fuel cell stack 100, adding cost, and making transportation of the stack more difficult. Typically, tolerable deflection of endplates 30, 32 is no greater than 0.002″, including less than 0.001″, including less than 0.00075″, and including a range of from about 0.0005″ to 0.002″.

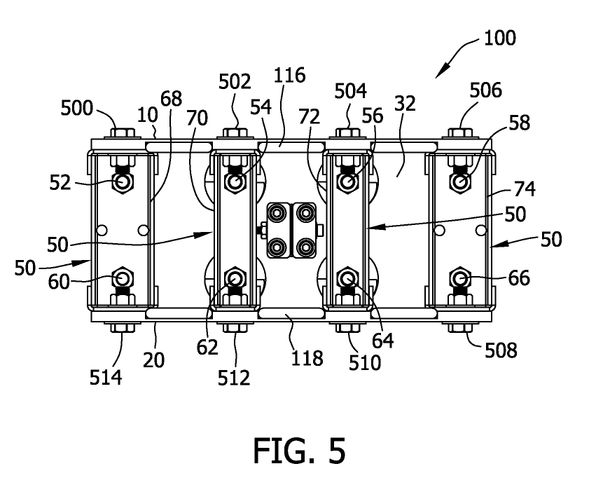

In one suitable embodiment, the fuel cell stack 100 includes a plurality of compression spring subassemblies, indicated generally at 50, for transferring force between the bipolar plates 34 and the heat exchangers 10, 20. In the illustrated embodiment, the fuel cell stack 100 has four compression spring subassemblies 50 but it is understood that the fuel cell stack can have more or fewer subassemblies. As seen in FIGS. 1 and 5, each of the compression spring subassemblies 50 includes a structural beam 68, 70, 72, 74 constrained by suitable fasteners 500, 502, 504, 506, 508, 510, 512, 514 (e.g., nuts, washers and bolts as illustrated in the accompany drawings). More specifically, the fasteners 500, 502, 504, 506, 508, 510, 512, 514 connect the respective structural beam 68, 70, 72, 74 to both the first heat exchanger 10 and the second heat exchanger 20. While described herein as using nuts, washers and bolts, it should be understood by one skilled in the art that other fasteners known in the art may be used to connect the structural beams 68, 70, 72, 74 to the heat exchangers 10, 20 without departing from the scope of the present disclosure.

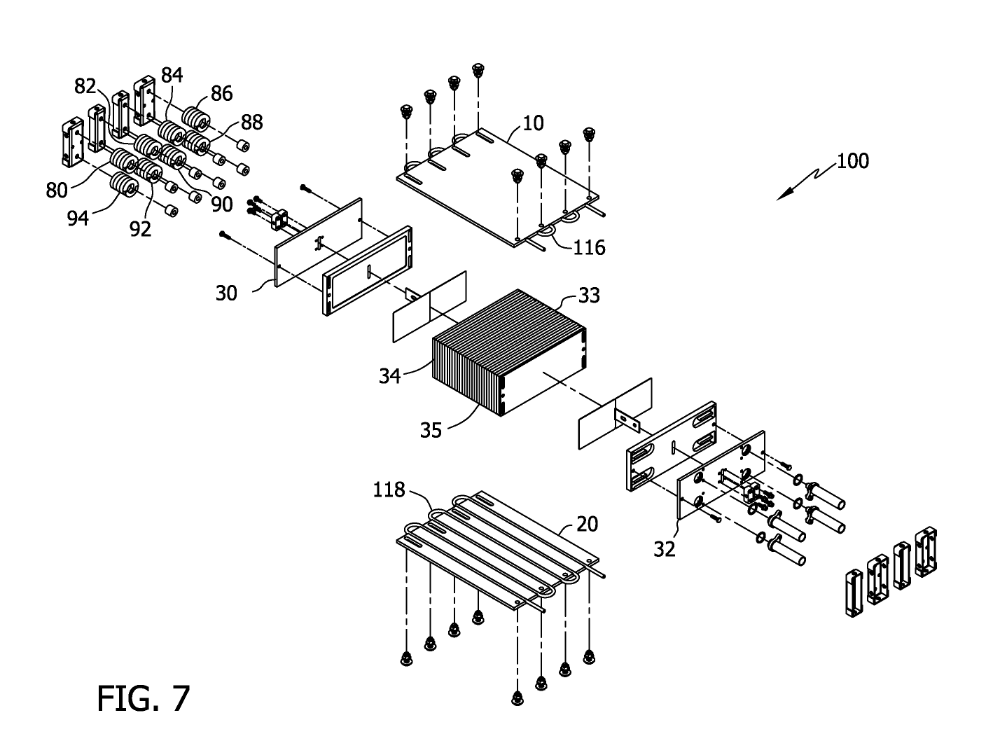

Further, eight helical die springs (as shown in FIG. 7 at 80, 82, 84, 86, 88, 90, 92, 94) are configured about studs 52, 54, 56, 58, 60, 62, 64, 66 mounted to respective structural beams 68, 70, 72, 74. These springs 80, 82, 84, 86, 88, 90, 92, 94 maintain stack compressive forces necessary for proper functioning while also accommodating movement due to thermal expansion of the stack. While shown herein as helical die springs, it should be understood that other suitable springs (e.g. leaf springs, spring washers, bevel washers, cup washers, etc.) as known in the art can be used in the compression spring subassembly without departing from the present disclosure. Further, while shown including eight springs, it should be understood that the compression spring subassembly can include more or less springs without departing from the present disclosure.

Conventional fuel cell stack designs typically locate a plurality of spring washers concentric to the tie rods, which are arranged around the outer perimeter of the bipolar plates. By contrast, the compression spring subassemblies 50 used with the fuel cell stack 100 of the present disclosure arranges the springs 80, 82, 84, 86, 88, 90, 92, 94 within the interior of the periphery of the cross-sectional area of the fuel cell stack. In this manner, compressive force is applied and maintained on the stack's interior components in a uniform manner where it is required, while eliminating the cantilevered load to the ends of the stack. This allows for the use of thinner, alternative materials for the endplates 30, 32 and other components, reducing thermal mass and size of the overall fuel cell stack. In some embodiments, by configuring the fuel cell stack 100 in the above manner, the endplates 30, 32 can be reduced in size and weight. For example, when using stainless steel for the endplate 30, 32 in a 36-cell stack (producing about 1 kW of power), the endplates may each have a thickness of from about 0.1875″ to about 0.375″, and suitably about 0.25″. Alternatively, the endplates 30, 32 of the fuel cell stack 100 may be made of moldable, light weight composite and/or plastic materials, further reducing weight of the endplate and resulting fuel cell stack. By reducing size and weight of the endplates 30, 32, the overall weight of the fuel cell stack 100 can be substantially reduced. For example, in some embodiments, the overall weight of a 36-cell fuel cell stack can be reduced by as much as 60%, including by as much as 70%, and including by as much as 80%.

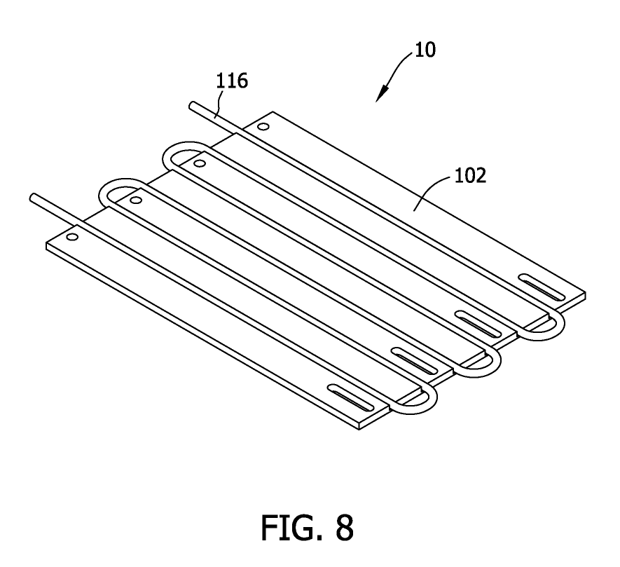

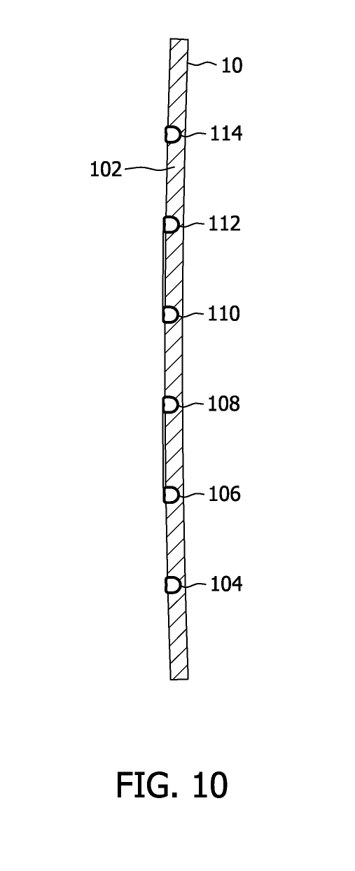

With reference now to FIG. 8, the illustrated first heat exchanger 10 is a flat tube-in plate heat exchanger. The heat exchanger 10 comprises a base material 102, such as aluminum, into which a series of channels 104, 106, 108, 110, 112, 114 (FIG. 10) has been machined or otherwise formed, and a continuous copper (or other suitable material) tube 116 has been bent and pressed into the channels.

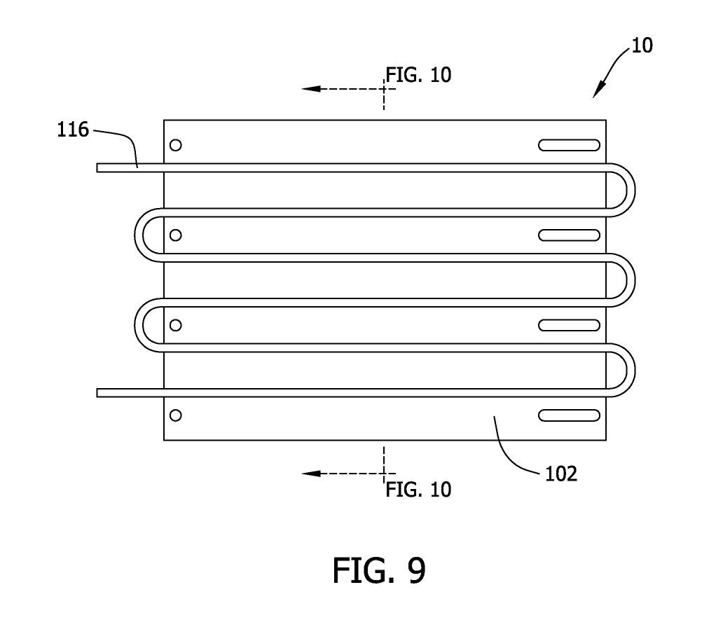

Although shown in FIGS. 8 and 9 as having a rectangular shape, it should be understood by one skilled in the art that the heat exchanger 10 can have any shape known in the art without departing from the present disclosure. Further, while the tube 116 is shown in FIGS. 8 and 9 as serpentine in shape, having five turns, it should be understood that the tube may be bent in various other configurations having more or less turns without departing from the present disclosure.

As seen in FIG. 10, the tube 116 has a generally race-tracked cross-section shape when pressed into the channels 104, 106, 108, 110, 112, 114 of the base material 102. However, it should be understood that the tube 116 may have any suitable cross-sectional shape (i.e., circular, rectangular, elliptical). As also seen in FIG. 10, the channels 104, 106, 108, 110, 112, 114 formed in the base material 102 are generally “U”-shaped in cross-section. It is understood, however that the channels 104, 106, 108, 110, 112, 114 can be machined in other shapes (e.g., “V”-shaped, rectangular, etc.) without departing from the present disclosure. In particularly suitable embodiments, the tube 116 has an outer diameter such that when pressed into the channels 104, 106, 108, 110, 112, 114, a sufficient portion of the tube 116 is pressed into contact with the total contact surface of the channels 104, 106, 108, 110, 112, 114. Suitable ratios of the outer diameter of the tube 116 to the width of the openings of the channel 104, 106, 108, 110, 112, 114 include from about 1:1.1 to about 1:1.45, including from about 1:1.2 to about 1:1.3, and including about 1:1.25.

By pressing the tube 116 tightly into the channels 104, 106, 108, 110, 112, 114 in such a manner, greater surface area contact between the tube, though which heat transfer fluid flows, and the base material 102, and thus, improved heat transfer is achieved. For example, in one embodiment, the tube 116 is in contact with at least 60% by total contact area of the channels 104, 106, 108, 110, 112, and 114, including with at least 70% by total contact area, including with at least 75% by total contact area, including with at least 80% by total contact area, and including being in contact with from about 86% to about 88% by total contact area of the channels 104, 106, 108, 110, 112, and 114.

Further, in one embodiment, by pressing the tube 116 such as to be in greater contact with the contact area of the channels 104, 106, 108, 110, 112, and 114, the heat exchangers 10, 20 are concavely bent about the channel edges as illustrated in FIG. 10. As the heat exchangers 10, 20 are then connected and then constrained by the fasteners 500, 502, 504, 506, and opposing fasteners 508, 510, 512, and 514 (FIG. 5) to the edges of the bipolar plates 34, better intimate contact between the heat exchangers 10, 20 and the edges 33, 35 of bipolar plates 34 is made.

In embodiments where the surface of the heat exchangers 10, 20 and the surface created by the edges 33, 35 of the bipolar plates 34 are not substantially flat, stack gaps may form between the two surfaces. In one suitable embodiment of the present disclosure, gap filling and contact resistance may be managed by introducing a formable heat transfer material between the heat exchangers 10, 20 and the edges 33, 35 of the bipolar plates 34. As used herein, “formable heat transfer material” refers to a material that has sufficient flexibility to conform to the gap it is placed within to fill. The heat exchangers 10, 20 and the formable heat transfer material can be firmly pressed against the edges 33, 35 of the bipolar plates 34 of the stack 100.

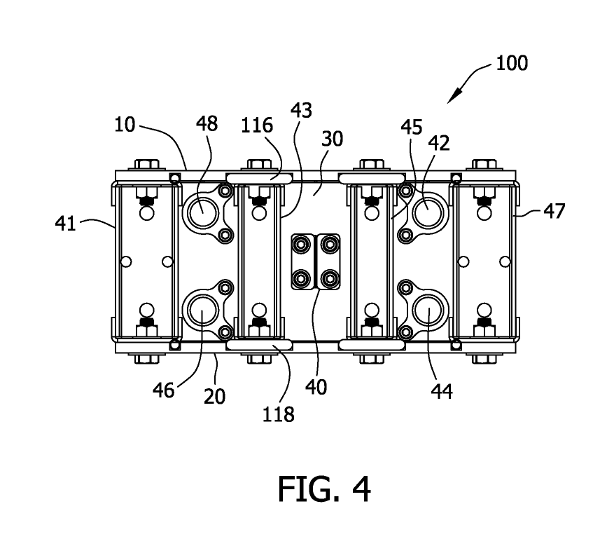

As noted above, the fuel cell stack 100 of FIGS. 1-7 has the plurality of compressive spring subassemblies 50 disposed at one of its ends. The opposing end of the fuel cell stack 100, as shown in FIG. 4, is free of compressive spring subassemblies 50. More specifically, the end of the fuel cell stack 100 free of compressive spring subassemblies 50 includes the endplate 30, a bus plate 40, tie rods 42, 44, 46, 48, and structural beams 41, 43, 45, 47. While shown as including four tie rods 42, 44, 46, 48, and four structural beams 41, 43, 45, 47, it should be understood that the opposing end of the fuel cell stack 100 may include more or less tie rods and/or more or less structural beams without departing from the present disclosure.

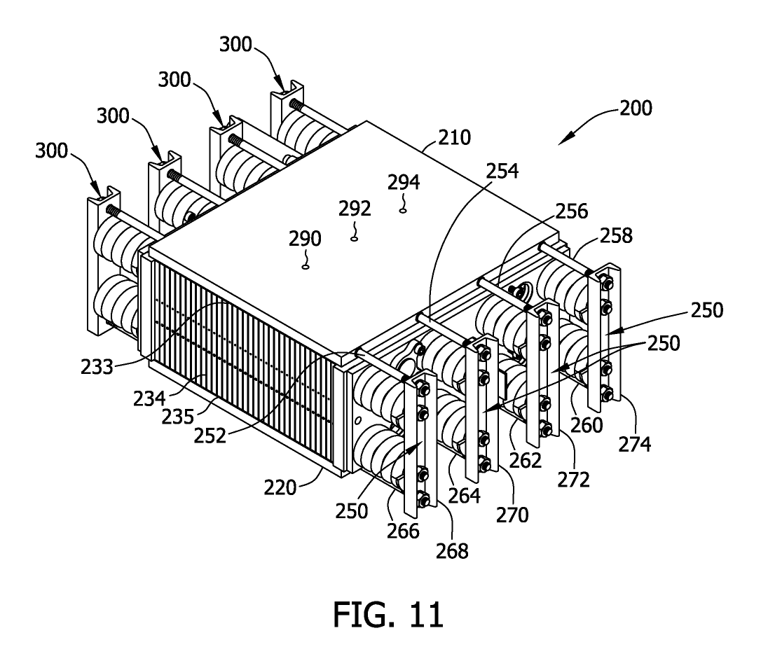

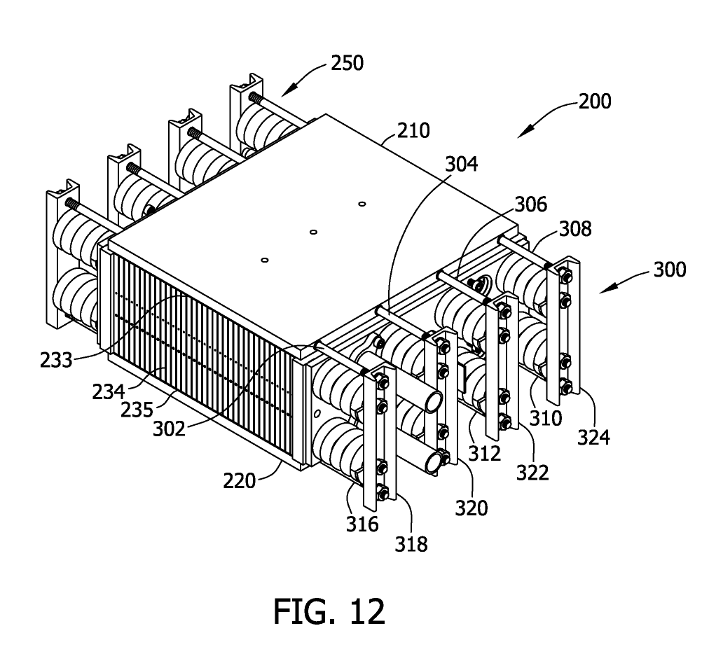

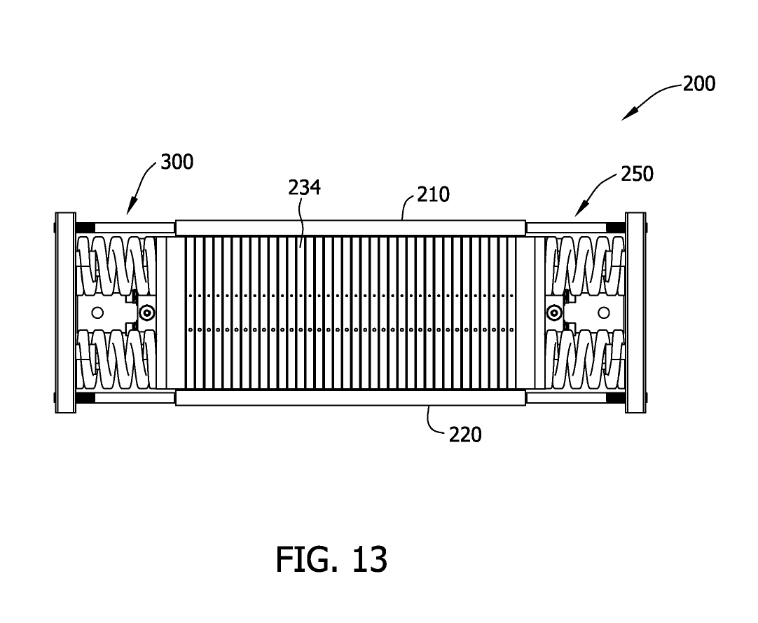

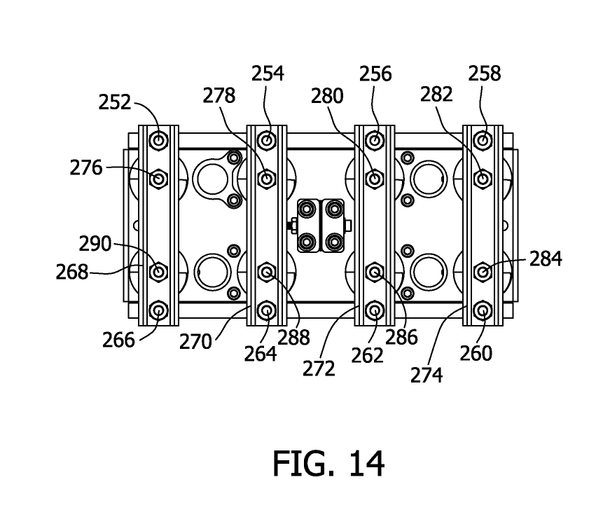

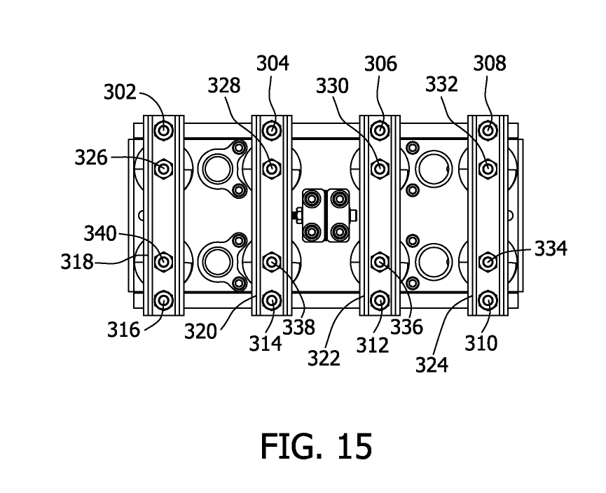

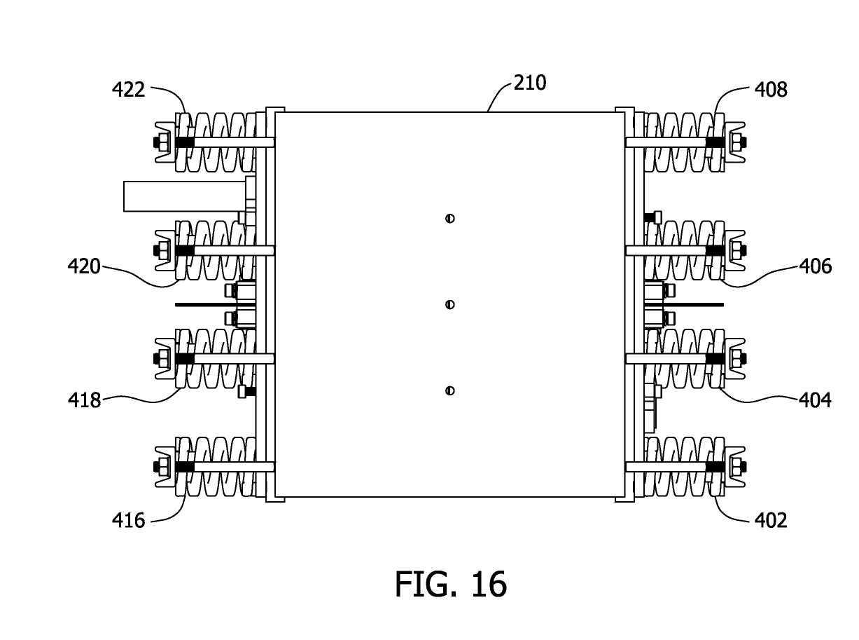

In other embodiments, such as shown in FIGS. 11-17, compressive spring subassemblies 250, 300 are located at both ends of a fuel cell stack 200 for transferring the compressive force from a plurality of bipolar plates 234 and MEAs (not shown) and applying a tensile force of equal magnitude to a pair of heat exchangers 210, 220. The compression spring subassemblies 250 at one end of the fuel cell stack 200, as shown in FIGS. 11 and 14, includes an upper tie rod 252, 254, 256, 258 secured to one of the heat exchanger 210 and a lower tie rod 260, 262, 264, 266 secured to the other heat exchanger 220. Structural beams 268, 270, 272, 274 are fastened to respective upper and lower tie rods and are fixed in position by nuts and washers connected to the tie rods. The compression spring subassemblies 300, as seen in FIGS. 12 and 15, includes an upper tie rod 302, 304, 306, 308 secured to one of the heat exchangers 210 and a lower tie rod 310, 312, 314, and 316 secured to the other heat exchanger 220. Four structural beams 318, 320, 322, 324 connect the upper and lower tie rods and are fixed in position by nuts and washers connected to the tie rods.

While shown as including eight total tie rods and four structural beams on each of the compression spring subassemblies 250, 300, it should be understood that more or less tie rods and more or less structural beams can be used in either or both of the compression spring subassemblies without departing from the present disclosure.

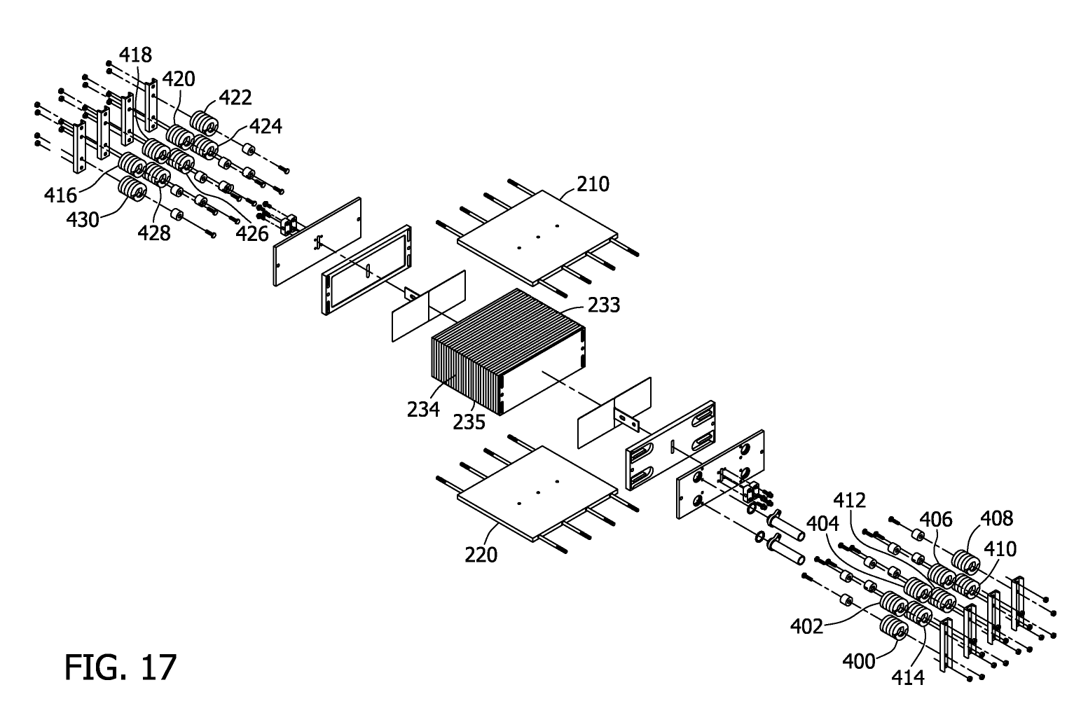

Further, eight helical die springs as shown in FIG.17, indicated at 400, 402, 404, 406, 408, 410, 412, 414 are configured around respective studs 276, 278, 280, 282, 284, 286, 288, 290 and eight helical die springs indicted in FIG. 17 as 416, 418, 420, 422, 424, 426, 428, 430 are configured around respective studs 326, 328, 330, 332, 334, 336, 338, 340. These springs maintain stack compressive forces necessary for proper functioning while also accommodating movement due to thermal expansion of the stack. While shown herein as helical die springs, it should be understood that any other suitable springs (e.g. leaf springs, spring washers, bevel washers, cup washers, etc.) as known in the art can be used in the compression spring subassemblies 250, 300 without departing from the present disclosure. Further, while shown including eight springs in each compression spring subassembly, it should be understood that each of the compression spring subassemblies can include more or less springs without departing from the present disclosure.

The heat exchangers 210, 220 for use in the fuel cell stack 200 use convection to heat and/or cool the fuel cell stack 200. More particularly, air is passed over the surface of the heat exchangers 210, 220, which include one or more ports (as shown in FIG. 11, three ports 290, 292, 294) for allowing the air to pass therethrough. It should be understood that more or less than three ports can be used in the heat exchangers without departing from the present disclosure.

Although shown in FIGS. 11-17 as having a square shape, it should be understood by one skilled in the art that the heat exchangers 210, 220 can be any suitable shape without departing from the present disclosure.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “top”, “bottom”, “above”, “below” and variations of these terms is made for convenience, and does not require any particular orientation of the components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fuel cell stack comprising:
a plurality of bipolar plates interleaved with membrane electrode assemblies; and
a heat exchanger operably connected to an edge of the bipolar plates and adapted to maintain a compressive force on the bipolar plates and membrane electrode assemblies.

2. The fuel cell stack of claim 1 further comprising at least one endplate that is operably connected with the bipolar plates and the heat exchanger.

3. The fuel cell stack of claim 1 wherein the heat exchanger maintains a compressive force of from about 25 psi to about 250 psi to compress the membrane electrode assemblies between the bipolar plates.

4. The fuel cell stack of claim 1 wherein the heat exchanger is a tube-in-plate heat exchanger comprising a channel having a tube pressed therein.

5. The fuel cell stack of claim 4 wherein the tube has an outer diameter and the channel has an opening with a width, and wherein a ratio of the outer diameter of the tube to the width of the opening of the channel is between about 1:1.1 and about 1:1.45.

6. The fuel cell stack of claim 5 wherein the tube-in-plate heat exchanger has a ratio of the outer diameter of the tube to the width of the opening of the channel of about 1:1.25.

7. The fuel cell stack of claim 1 further comprising a second heat exchanger operably connected to an opposing edge of the bipolar plates from the first heat exchanger.

8. The fuel cell stack of claim 7 further comprising a compression spring subassembly including a structural beam extending between the first and second heat exchangers and at least one spring connected to the structural beam for transferring force between the bipolar plates and each of the first and second heat exchangers.

9. The fuel cell stack of claim 7 further comprising a compression spring subassembly including a plurality of structural beams extending between the first and second heat exchangers and at least one spring connected to each of the structural beams for transferring force between the bipolar plates and each of the first and second heat exchangers.

10. The fuel cell stack of claim 1 further comprising a formable heat transfer material located between the heat exchanger and the edge of the bipolar plates.

11. A fuel cell stack comprising:
a plurality of bipolar plates interleaved with membrane electrode assemblies; and
a heat exchanger operably connected to an edge of the bipolar plates and adapted to maintain a compressive force on the bipolar plates and membrane electrode assemblies, wherein the heat exchanger has an in-plane coefficient of thermal expansion similar to the through-plane coefficient of thermal expansion of the bipolar plate.

12. The fuel cell stack of claim 11 wherein the heat exchanger maintains a compressive force of from about 25 psi to about 250 psi to compress the membrane electrode assemblies between the bipolar plates.

13. The fuel cell stack of claim 11 wherein the bipolar plate comprises a material possessing a through-plane coefficient of thermal expansion of between about 2.3×10⁻⁰⁵ in/in° C. and about 2.5×10⁻⁰⁵ in/in° C.

14. The fuel cell stack of claim 13 wherein the heat exchanger comprises a material possessing an in-plane coefficient of thermal expansion of between about 2.4×10⁻⁰⁵ in/in° C. an about 2.5×10⁻⁰⁵ in/in° C.

15. The fuel cell stack of claim 11 further comprising a formable heat transfer material located between the heat exchanger and the edge of the bipolar plates.

16. A fuel cell stack comprising:
a plurality of bipolar plates interleaved with membrane electrode assemblies;
a first heat exchanger operably connected to an edge of the bipolar plates;
a second heat exchanger operably connected to an opposing edge of the bipolar plates, wherein the first and second heat exchangers are adapted to maintain a compressive force on the bipolar plates and membrane electrode assemblies, and wherein at least one of the first and second heat exchanger has an in-plane coefficient of thermal expansion similar to the through-plane coefficient of thermal expansion of the bipolar plates; and
a compression spring subassembly including a structural beam extending between the first and second heat exchangers and at least one spring connected to the structural beam for transferring force between the bipolar plates and each of the first and second heat exchangers.

17. The fuel cell stack of claim 16 wherein the compression spring subassembly comprises a plurality of structural beams extending between the first and second heat exchangers and at least one spring connected to each of the structural beams for transferring force between the bipolar plates and each of the first and second heat exchangers.

18. The fuel cell stack of claim 17 wherein the heat exchanger maintains a compressive force of from about 25 psi to about 250 psi to compress the membrane electrode assemblies between the bipolar plates.

19. The fuel cell stack of claim 17 wherein at least one of the first and second heat exchanger is a tube-in-plate heat exchanger comprising a channel having a tube pressed therein, wherein the tube has an outer diameter and the channel has an opening with a width, and wherein a ratio of the outer diameter of the tube to the width of the opening of the channel is between about 1:1.1 and about 1:1.45.

20. The fuel cell stack of claim 17 further comprising a formable heat transfer material located between at least one of the first and second heat exchanger and the edge of the bipolar plates.
